(19) United States
(12) Patent Application Publication
(10) Pub. No.: US 2012/0313978 A1
(43) Pub. Date: Dec. 13, 2012

(54) DRIVING METHOD USING PHASE DIFFERENCE TO CONTROL LUMINANCE OF FIELD EMISSION STRUCTURE AND DISPLAY APPARATUS USING THE SAME

(76) Inventors: Chih-Che Kuo, Hsin-Chu (TW); Sheng-Cheng Chiu, Hsin-Chu (TW)

(21) Appl. No.: 13/300,679

(22) Filed: Nov. 21, 2011

(30) Foreign Application Priority Data
Jun. 8, 2011 (TW) 100119978

(51) Int. Cl. G09G 5/10

(52) U.S. Cl. 345/690

(57) ABSTRACT

A driving method for a field emission structure including at least a pixel, each including a first emitter, a second emitter, a first electrode utilized to control the first emitter, and a second electrode utilized to control the second emitter, includes: receiving a first control signal and a second control signal; and controlling the first emitter and the second emitter according to the first control signal and the second control signal, wherein when the first control signal and the second control signal have a first phase difference, electrons emitted by the first emitter and the second emitter have a first intensity, and when the first control signal and the second control signal have a second phase difference different from the first phase difference, electrons emitted by the first emitter and the second emitter have a second intensity different from the first intensity.

### BACKGROUND OF THE INVENTION

1. Field of the Invention

The disclosed embodiments of the present invention relate to drive a field emission structure of a display apparatus, and more particularly, to a driving method using phase difference to control luminance of a field emission pixel structure and a display apparatus applying the driving method.

2. Description of the Prior Art

Field emission display (FED) technology has come into favor as a technology for developing low power and flat panel displays. An FED normally includes a substrate (cathode plane), a faceplate (anode plate) disposed parallel to the substrate, and a narrow vacuum gap sandwiched in between the substrate and the faceplate. At low electric field (typically in the range of 1 to 20 V/μm), the FED can emit electrons with sufficient current density (typically in the range of 10 to 100 mA/cm2) so as to generate bright fluorescence light from a phosphor layer disposed on the faceplate.

Please refer to FIG. 1, which is a schematic diagram of a structure of a conventional lateral field emission device 1000. The main structure of the lateral field emission element 1000 includes an anode 1100 covered with fluorescent powders, a coplanar gate 1200 and cathode 1300, and an emitter 1400, where the lateral field emission element 1000 has a three-electrode structure. Please refer to FIG. 2, which is a top view of a lateral cathode structure of the conventional lateral field emission device 1000. Regarding such a structural design, the gate 1200 receives a voltage to trigger electrons to be emitted from the emitter 1400 and then attracted by the high voltage of the anode 1100 to bombard the fluorescent powders to form fluorescence. Due to the limit of this structure, the field emission area of the emitter cannot be increased significantly, thus limiting the size of the fluorescent area. Were current density on a carbon nanotube increased in order to enhance luminance efficiency, the carbon nanotube might be easily damaged, which shortens the life expectancy of the field emission device.

Therefore, how to improve the conventional lateral field emission structure and enhance luminance efficiency while prolonging the life expectancy of field emission device is a big problem to be solved in this field.

### SUMMARY OF THE INVENTION

In accordance with exemplary embodiments of the present invention, a driving method using phase difference to control luminance of a field emission pixel structure and a display apparatus using the same are proposed to solve the above-mentioned problem. Specifically, the present invention proposes a driving method for a field emission pixel structure with high luminance efficiency as well as longer life expectancy, and relayed display apparatus employing the proposed driving method.

According to a first aspect of the present invention, an exemplary driving method for a field emission structure is disclosed. The driving method for a field emission structure including at least a pixel, each including a first emitter, a second emitter, a first electrode utilized to control the first emitter, and a second electrode utilized to control the second emitter, includes: receiving a first control signal and a second control signal; and controlling the first emitter and the second emitter according to the first control signal and the second control signal, wherein when the first control signal and the second control signal have a first phase difference, electrons emitted by the first emitter and the second emitter have a first intensity, and when the first control signal and the second control signal have a second phase difference different from the first phase difference, electrons emitted by the first emitter and the second emitter have a second intensity different from the first intensity.

According to a second aspect of the present invention, an exemplary display apparatus applying the driving method is disclosed. The display apparatus includes at least one pixel and a driving circuit. Each of the at least one pixel includes a first emitter, a second emitter, a first electrode utilized to receive a first control signal and a second electrode utilized to receive a second control signal. The driving circuit is coupled to the at least one pixel, for generating the first control signal and the second control signal. The first emitter and the second emitter emit electrons according to the first control signal and the second control signal. When the first control signal and the second control signal have a first phase difference, electrons emitted by the first emitter and the second emitter have a first intensity, and when the first control signal and the second control signal have a second phase difference different from the first phase difference, electrons emitted by the first emitter and the second emitter have a second intensity different from the first intensity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a structure of a conventional lateral field emission device.

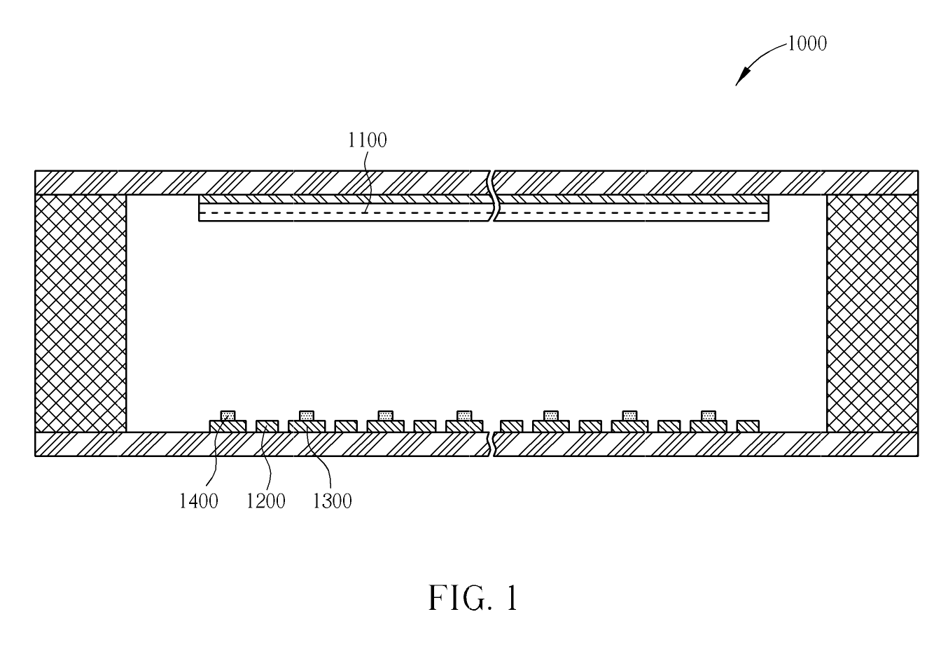

FIG. 2 is a top view of a lateral cathode structure of the conventional lateral field emission device shown in FIG. 1.

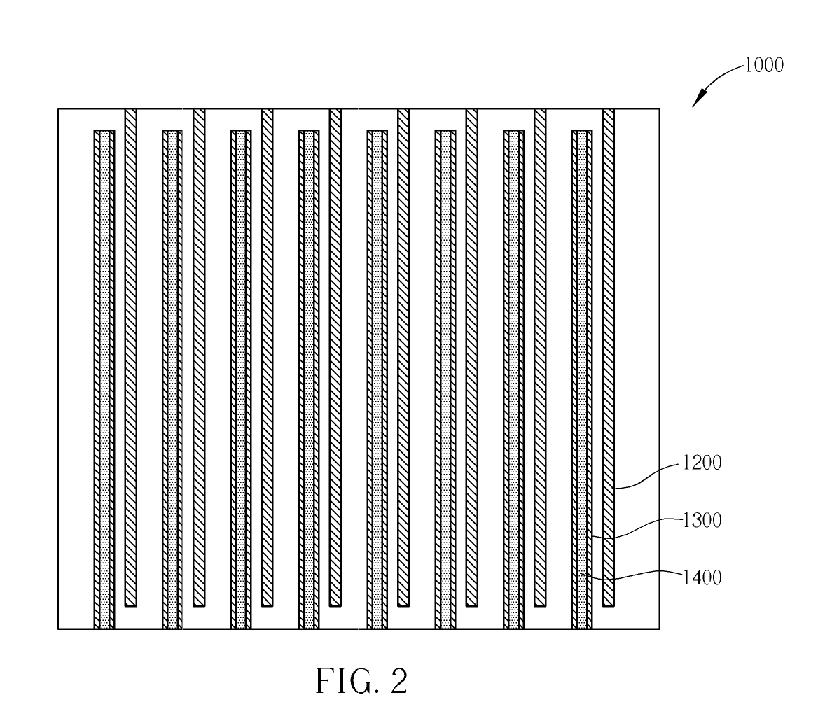

FIG. 3 is a schematic diagram of a pixel structure of a display apparatus according to an embodiment of the present invention.

FIG. 4 is a schematic diagram of driving signals when a phase difference of a first control signal and a second control signal is 180 degrees according to an embodiment of the present invention.

FIG. 5 is a schematic diagram of driving signals when a phase difference of a first control signal and a second control signal is 90 degrees according to an embodiment of the present invention.

FIG. 6 is a schematic diagram of a pixel structure of a display apparatus according to another embodiment of the present invention.

FIG. 7 is a schematic diagram of a pixel structure of a display apparatus according to yet another embodiment of the present invention.

### DETAILED DESCRIPTION

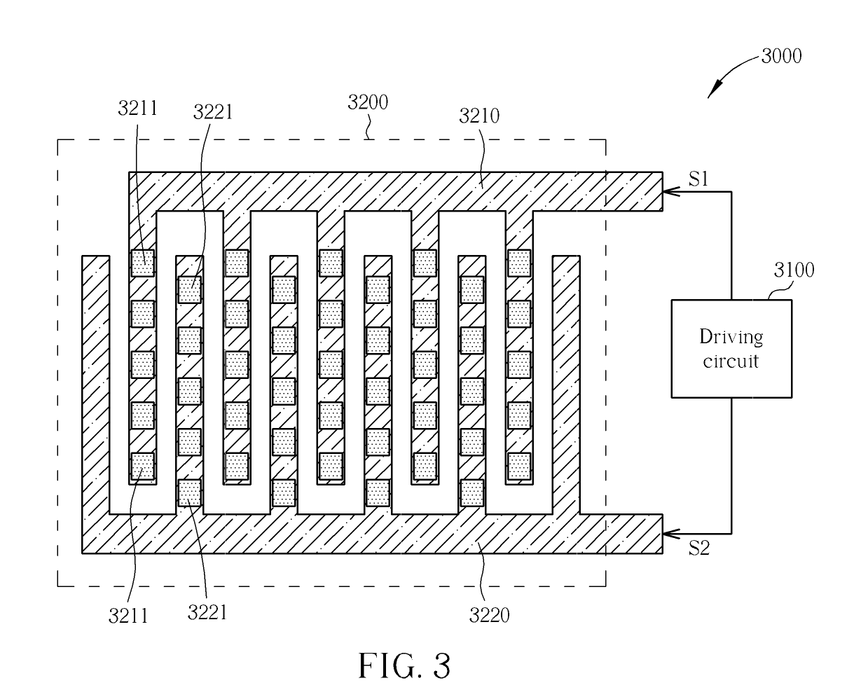

Please refer to FIG. 3, which is a schematic diagram of a pixel structure of a display apparatus 3000 according to an embodiment of the present invention. The display system 3000 includes, but not limited to, a driving circuit 3100 and at least one pixel. It should be noted that only one pixel 3200 is shown in FIG. 3 for clarity and simplicity. The pixel 3200 in the display system 3000 includes a first electrode 3210 for receiving a first control signal S1, a second electrode 3220 for receiving a second control signal S2, a first emitter 3211 and a second emitter 3221, wherein the first emitter 3211 is disposed on the first electrode 3210, and the second emitter 3221 is disposed on the second electrode 3220. The driving circuit 3100 is coupled to the pixel 3200, and arranged to generate the first control signal S1 and the second control signal S2, wherein the first emitter 3211 and the second emitter 3221 emit electrons according to the first control signal S1 and the second control signal S2. When the first control signal S1 and the second control signal S2 have a first phase difference, the electrons emitted by the first emitter 3211 and the second emitter 3221 have a first intensity, and when the first control signal S1 and the second control signal S2 have a second phase difference different from the first phase difference, the electrons emitted by the first emitter 3211 and the second emitter 3221 have a second intensity different from the first intensity. Since a field emission display apparatus provides bright fluorescence by using emitted electrons to hit a phosphor layer, when the intensity of the emitted electrons changes, the displayed luminance changes as well. Hence, the driving method of the field emission structure proposed by the present invention can make the pixel 3200 present different grayscales by inputting the first and second control signals S1, S2 with different phase differences.

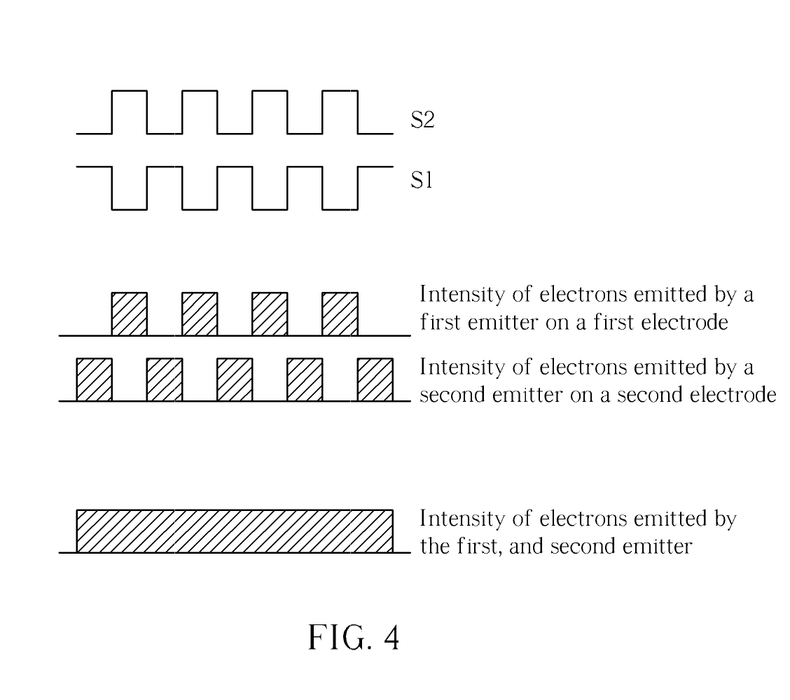

Please note that, in this embodiment, the first emitter 3211 and the second emitter 3221 are respectively disposed on the corresponding first electrode 3210 and second electrode 3220, and the first electrode 3210 and the second electrode 3220 alternatively serve as a gate and a cathode according to the respectively received first control signal S1 and second control signal S2. In this embodiment, the first and second control signals S1, S2 are both periodical signals. Please refer to FIG. 4 to have a better understanding of operations of the display system 3000. FIG. 4 is a schematic diagram of driving signals when a phase difference between the first control signal S1 and second control signal S2 is 180 degrees according to an embodiment of the present invention. As can be known from FIG. 4, when the first control signal S1 is at high electric potential, and the second control signal S2 is at low electric potential, the first electrode 3210 will serve as the gate and excite the second emitter 3221 on the second electrode 3220 that serves as the cathode at this moment, which makes the second emitter 3221 emit electrons. Similarly, when the second control signal S2 is at high electric potential, and the first control signal S1 is at low electric potential, the second electrode 3220 will serve as the gate and excite the first emitter 3211 on the first electrode 3210 that serves as the cathode at this moment. Compared with the conventional field emission structure under the same premise of having the same brightness, the display system 3000 proposed by the present invention can lower a frequency of a periodical control signal, which is roughly half of a frequency of the conventional control signal.

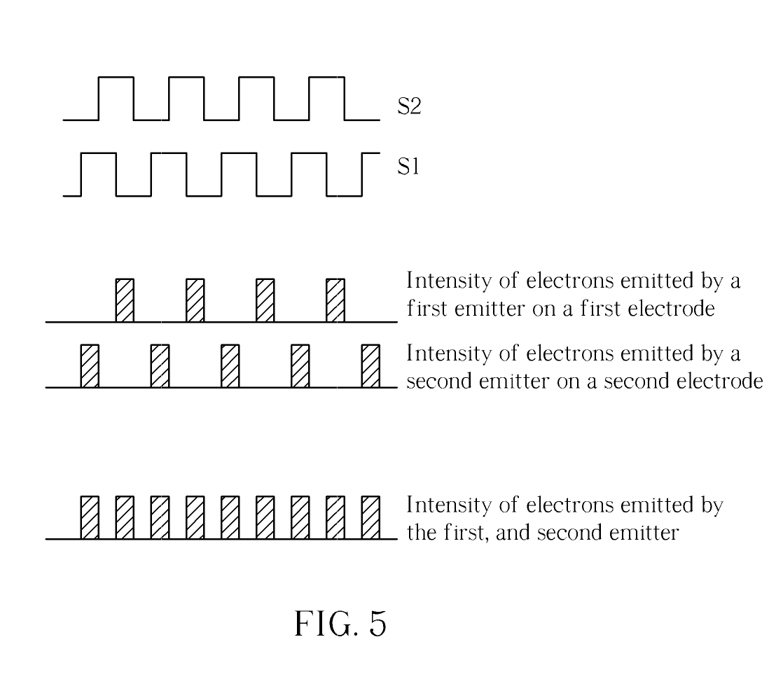

FIG. 5 is a schematic diagram of driving signals when a phase difference of the first control signal S1 and second control signal S2 is 90 degrees according to an embodiment of the present invention. As can be known from FIG. 5, when the first and second control signals S1, S2 are concurrently at high electric potential or concurrently at low electric potential (i.e., there is no potential difference between the first electrode 3210 and the second electrode 3220), neither the first emitter 3211 nor the second emitter 3221 will be excited to emit electrons. Due to the 90-degree phase difference of the first and second control signals S1, S2 in FIG. 5, during each full period, the first and second control signals S1, S2 are at different electric potential for a half period, and therefore the brightness presented by the pixel 3200 is only half of that presented by the embodiment shown in FIG. 4.

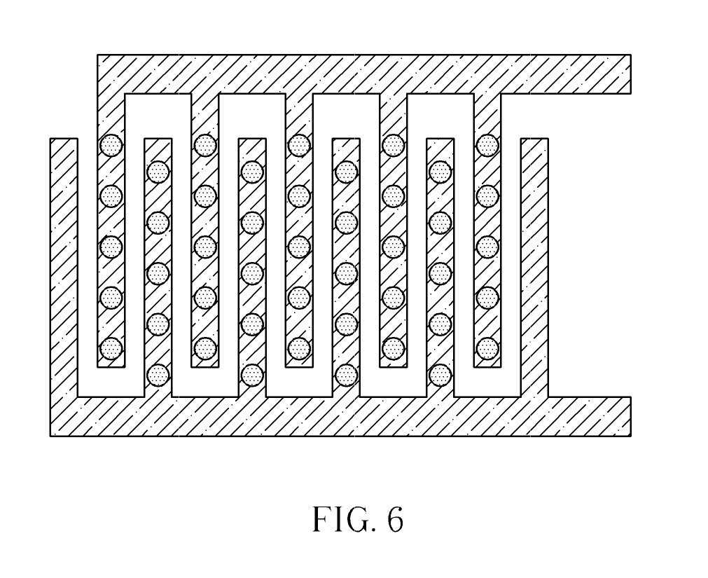

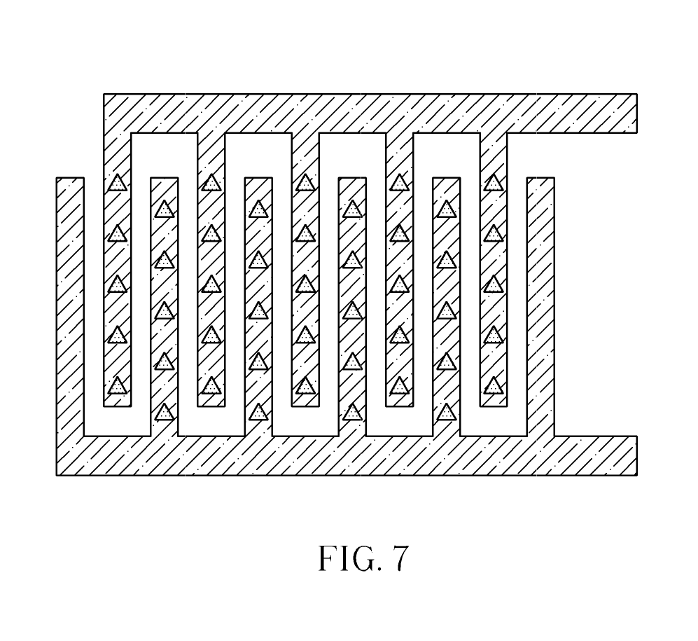

The aforementioned embodiments are only for illustration of the operations/effects of the present invention, and are not meant to be limitations of the scope of the present invention. For example, besides the phase difference, brightness adjustment may also be realized by means of control signal's amplitude, duty cycle, etc. In addition, the first emitter 3211 and the second emitter 3221 are not limited to have a square shape, and they may also have a circular shape or a triangular shape. Please refer to FIG. 6 and FIG. 7. FIG. 6 is a schematic diagram of a pixel structure of a display apparatus according to another embodiment of the present invention, and FIG. 7 is a schematic diagram of a pixel structure of a display apparatus according to yet another embodiment of the present invention. The pixel structure shown in FIG. 6 utilizes emitters having a circular shape, while the pixel structure shown in FIG. 7 utilizes emitters having a triangular shape.

Please refer to FIG. 3 again. In order to make the pixel 3200 evenly present right luminance, the first emitter 3211 is disposed along a first horizontal line, the second emitter 3221 is disposed along a second horizontal line different from the first horizontal, and the first emitter 3211 and the second emitter 3221 are staggered in a vertical direction. That is, the first emitter 3211 and the second emitter 3221 would be staggered in the directions of the first electrode 3210 and the second electrode 3220, to thereby gain more efficient lighting. In addition, in aforementioned embodiments, an emitter needs to sense an electric field greater than a predetermined threshold to emit electrons. Taking a carbon nanotube used as an emitter for example, the distance between two electrodes is 100 microns. When the first control signal S1 (e.g., 50V) is greater than the second control signal S2 (e.g., 0V) plus the predetermined threshold value (e.g., 200V), the pixel 3200 controls the first electrode 3210 to excite the second emitter 3221 to emit electrons; similarly, when the second control signal S2 is greater than the first control signal S1 plus the predetermined threshold value, the pixel 3200 controls the second electrode 3220 to excite the first emitter 3211 to emit electrons.

To sum up, the present invention provides a driving method of a field emission pixel structure and a display apparatus employing the proposed driving method, which utilize parameter(s), such as phase difference, to control the displayed grayscales, thereby enhancing luminance efficiency and prolonging the life expectancy.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving method for a field emission structure, the field emission structure comprising at least a pixel, each comprising a first emitter, a second emitter, a first electrode utilized to control the first emitter, and a second electrode utilized to control the second emitter, the driving method comprising:
receiving a first control signal and a second control signal; and
controlling the first emitter and the second emitter according to the first control signal and the second control signal, wherein when the first control signal and the second control signal have a first phase difference, electrons emitted by the first emitter and the second emitter have a first intensity, and when the first control signal and the second control signal have a second phase difference different from the first phase difference, electrons emitted by the first emitter and the second emitter have a second intensity different from the first intensity.

2. The driving method of claim 1, wherein the step of controlling the first emitter and the second emitter according to the first control signal and the second control signal comprises:
controlling the second emitter to emit electrons when the first control signal is greater than second control signal plus a predetermined threshold value; and
controlling the first emitter to emit electrons when the second control signal is greater than first control signal plus the predetermined threshold value.

3. The driving method of claim 1, wherein the step of receiving the first control signal and the second control signal comprises:
receiving a first periodic signal as the first control signal; and
receiving a second periodic signal as the second control signal.

4. A display apparatus, comprising:
at least one pixel, each comprising:
a first emitter;
a second emitter;
a first electrode, utilized to receive a first control signal; and
a second electrode, utilized to receive a second control signal; and
a driving circuit, coupled to the at least one pixel, for generating the first control signal and the second control signal;
wherein the first emitter and the second emitter emit electrons according to the first control signal and the second control signal; when the first control signal and the second control signal have a first phase difference, electrons emitted by the first emitter and the second emitter have a first intensity; and when the first control signal and the second control signal have a second phase difference different from the first phase difference, electrons emitted by the first emitter and the second emitter have a second intensity different from the first intensity.

5. The display apparatus of claim 4, wherein when the first control signal is greater than second control signal plus a predetermined threshold value, the pixel controls the second emitter to emit electrons via first electrode; and when the second control signal is greater than first control signal plus the predetermined threshold value, the pixel controls the first emitter to emit electrons via second electrode.

6. The display apparatus of claim 4, wherein the first emitter is disposed on the first electrode along a first horizontal line, the second emitter is disposed on the second electrode along a second horizontal line different from the first horizontal line, and the first emitter and the second emitter are staggered in a vertical direction.

7. The display apparatus of claim 4, wherein each of the first emitter and the second emitter has a square shape, a circular shape, or a triangular shape.

8. The display apparatus of claim 4, wherein the display apparatus has pixels arranged in a matrix, a plurality of pixels located on a same row receive the first control signal, and a plurality of pixels located on a same column receive the second control signal.

9. The display apparatus of claim 4, wherein the first emitter is disposed on the first electrode and the second emitter is disposed on the second electrode.
